(19) United States
(12) Patent Application Publication
(10) Pub. No.: US 2009/0171605 A1
(43) Pub. Date: Jul. 2, 2009

(54) Method and System for Defect Inspection

(75) Inventor: Gary Thomson, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/965,292

(22) Filed: Dec. 27, 2007

(51) Int. Cl. G06F 19/00

(52) U.S. Cl. 702/81

(57) ABSTRACT

In one embodiment, a method includes receiving inspection data from an optical inspection tool. The inspection data represents a plurality of surface features of a substrate. The inspection data is compared to a first pattern. The first pattern corresponds to a second pattern formed by dispensing a flowing substance on a surface of the substrate. The method further includes determining, based at least in part on the comparison, if the inspection data indicates one or more defects.

### TECHNICAL FIELD

The present disclosure relates generally to wafer processing, and more particularly to a method and system for defect inspection.

### BACKGROUND

Semiconductor devices are often processed and packaged at the wafer level. Some processing and packaging steps generate particles that may negatively impact device performance and reliability. Some such particles may be less than two microns in diameter.

### SUMMARY

In one embodiment, a method includes receiving inspection data from an optical inspection tool. The inspection data represents a plurality of surface features of a substrate. The inspection data is compared to a first pattern. The first pattern corresponds to a second pattern formed by dispensing a flowing substance on a surface of the substrate. The method further includes determining, based at least in part on the comparison, if the inspection data indicates one or more defects.

An advantage of certain embodiments of the present disclosure may be that a stand-alone, configurable, data-analyzer application can analyze off-line inspection data generated by any of a variety of inspection tools. Another advantage of certain embodiments is that lower-precision and less-repeatable processes, such as epoxy droplet dispensing, may be analyzed, characterized, and optimized. In addition, some embodiments may be able to generate and analyze inspection data corresponding to the application of a flowing substance to a wafer.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a portion of an inspection system according to one embodiment;

FIG. 2A illustrates a top view of a wafer including features that may be inspected by the inspection system of FIG. 1 according to one embodiment;

FIG. 2B illustrates an example zoomed portion of the wafer of FIG. 2A having flowing surface features formed in a particular pattern;

FIG. 2C illustrates the example zoomed portion of FIG. 2B after flowing surface features have flowed to form a new pattern;

FIG. 3A illustrates an example portion of an analytical mask that may be used to extrapolate defect information from the data generated by the inspection system of FIG. 1 according to one embodiment;

FIG. 3B illustrates an example portion of a defect map that graphically represents the extrapolated defect information of FIG. 3A according to one embodiment; and

FIG. 4 illustrates an example of a method that may be performed by the inspection system of FIG. 1 according to one embodiment.

### DETAILED DESCRIPTION

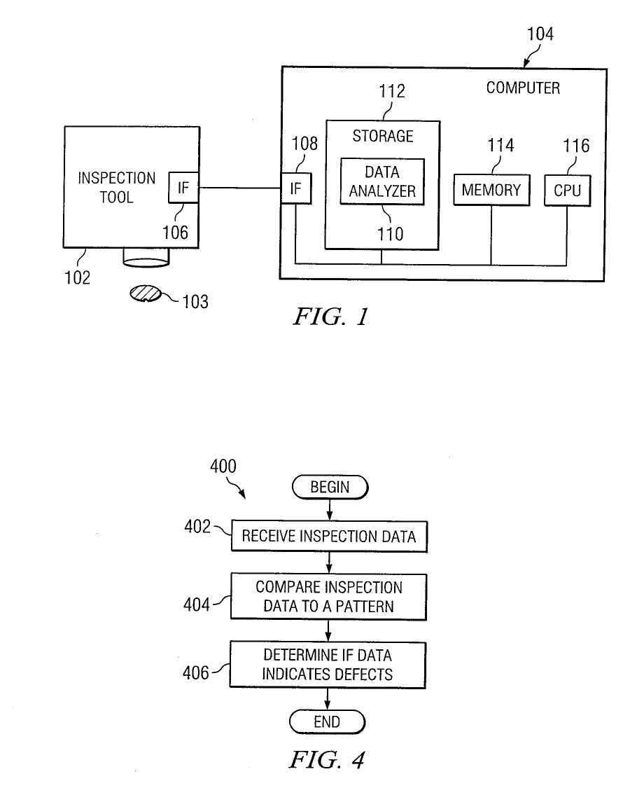

FIG. 1 illustrates a portion of an inspection system 100 according to one embodiment. In this example, inspection system 100 generally includes an inspection tool 102 and a computer 104 communicatively coupled together through respective interfaces 106 and 108. In operation, a data-analyzer application 110 residing within storage 112 of computer 104 may generate defect information by analyzing data received from inspection tool 102. For example, data-analyzer application 110 may compare the data generated by inspection tool 102 to a predetermined pattern and determine if the data indicates one or more defects on the surface of an inspected wafer 103.

Inspection tool 102 generally refers to any device operable to generate data corresponding to the features of an inspection sample. For example, in some embodiments, inspection tool 102 may be capable of generating spatial data corresponding to micron-sized particles distributed across the surface of wafer 103; however, inspection tool 102 may be capable of detecting any of a variety of surface or internal features of the inspection sample. Examples of some such inspection tools 102 may include KLA-TENCOR SURFSCAN tools, Charge-Coupled Device (CCD) cameras, and/or any other device operable to generate data corresponding to the features of an inspection sample. Inspection tool 102 communicates its generated data to computer 104 through interface 106 using any suitable communication link. For example, the communication link between inspection tool 102 and computer 104 may be hardwired, wireless, a network, other suitable communication link, and/or any combination of the preceding. In some alternative embodiments, computer 104 may be an integrated component of inspection tool 102.

Computer 104 generally refers to any device operable to analyze data generated by inspection tool 102. For example, computer 104 may include a personal digital assistant, a computer laptop or desktop workstation, a cellular telephone, a mobile handheld device, or any other device to analyze data generated by inspection tool 102. Computer 104 may execute with any of the well-known MS-DOS, PC-DOS, OS-2, MAC-OS, WINDOWS™, UNIX, or other appropriate operating systems, including future operating systems. In this example, the main components of computer 104 generally include an interface 108 operable to receive communications from inspection tool 102, a data-analyzer application 110 residing within storage 112, a memory 114, and a central processing unit (CPU) 116.

Data-analyzer application 110 generally refers to any suitable logic embodied in tangible computer-readable media and operable when executed to analyze data generated by inspection tool 102. Logic may include hardware, software, and/or other logic. Memory 114 generally refers to one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium. CPU 116 generally refers to logic that executes instructions to generate output.

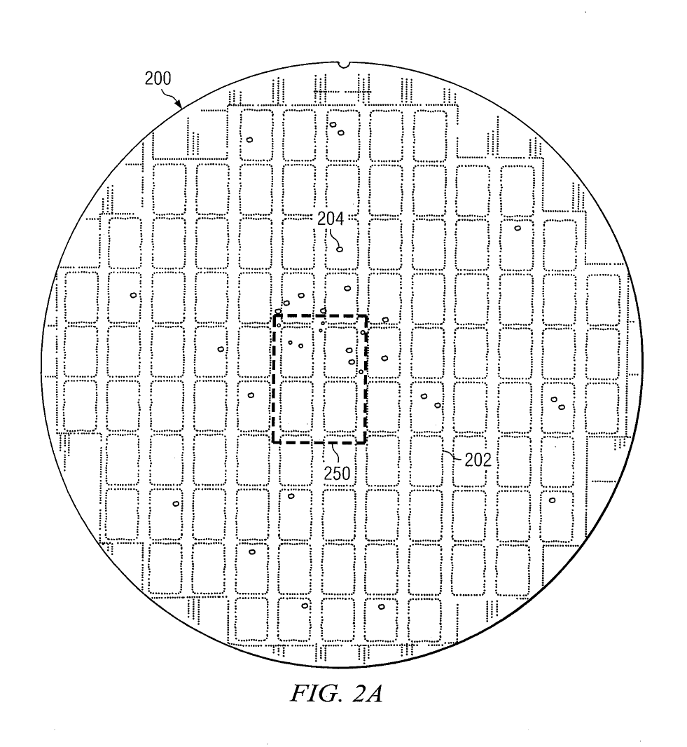

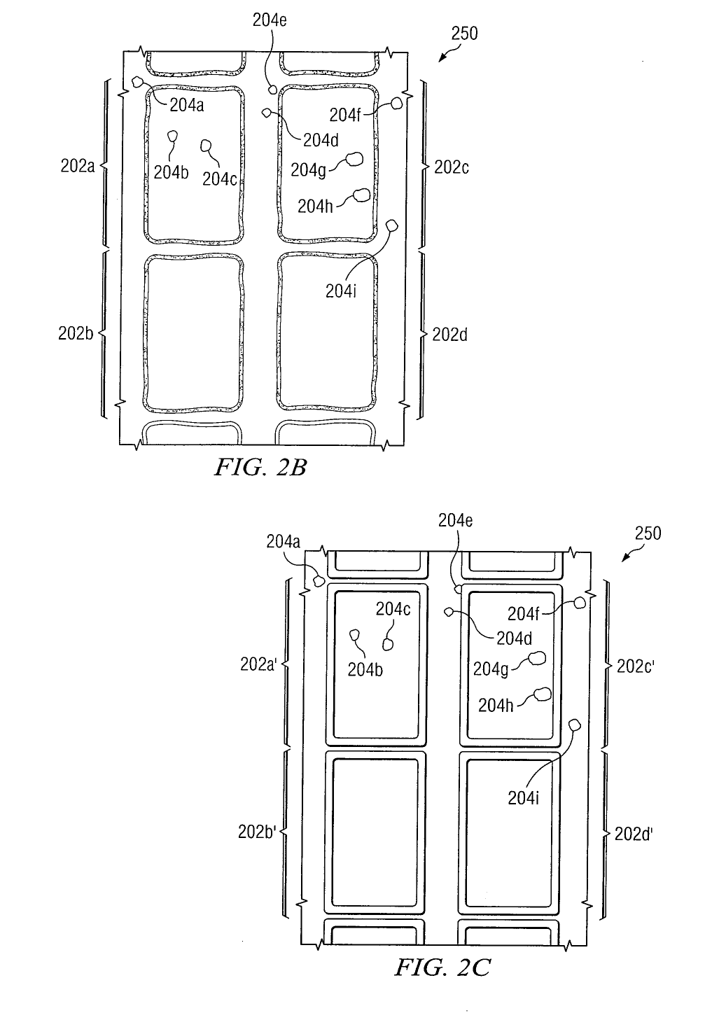

Modifications, additions, or omissions may be made to system 100 without departing from the scope of the present disclosure. The components of system 100 may be integrated or separated. For example, all or a portion of data-analyzer application 112 may alternatively reside either permanently or temporarily in memory 114, or in any other suitable device operable to store and facilitate retrieval of data and instructions. Moreover, the operations of system 100 may be performed by more, fewer, or other components. For example, some of the functions performed by data-analyzer application 110 may also be performed by various other computation devices including, but not limited to, a calculator. Additionally, operations of system 100 may be performed using any suitable logic. As used in this document, “each” refers to each member of a set or each member of a subset of a set. Further details regarding the example operations that may be performed by data-analyzer application 110 upon the data generated by inspection tool 102 are described further below with respect to FIGS. 2A through 3B.

FIG. 2A illustrates a top view of a wafer 200 including features 202 and 204 that may be inspected by inspection tool 102 of FIG. 1 according to one embodiment. More specifically, in the illustrated example, wafer 200 generally includes a pattern of multiple similarly configured features 202 formed by dispensing a flowing substance on a surface of the wafer. Wafer 200 also includes several aberrations (e.g., 204) that do not appear to fit the general pattern. In some embodiments, wafer 200 may be used, for example, to form a capping substrate that may be bonded to a base substrate (not explicitly shown) having features corresponding in shape to features 202. Details regarding forming a pattern by dispensing or otherwise applying a flowing substance to wafer 200 are explained further with reference to FIG. 2B.

FIG. 2B illustrates an example zoomed portion 250 of the wafer 200 of FIG. 2A that includes surface features 202 and 204 formed in a particular pattern. In particular, the illustrated portion 250 of wafer 200 generally includes four rectangular-shaped initial dispense patterns 202a-202d and several aberrations 204a-204i. The rectangular-shaped dispense patterns 202a-202d have non-continuous contours that may be formed, for example, by dispensing an epoxy as droplets or “dots” in a predetermined pattern across the surface of wafer 200; however, any suitable flowing substance, pattern, and/or dispense technique may be used. In some embodiments, aberrations 204a-204i may be undesired byproducts resulting from the formation of patterns 202a-202d. After a flowing substance is dispensed or otherwise applied to wafer 200 in a particular pattern, it may flow in a manner that forms a different pattern, as illustrated further with reference to FIG. 2C.

FIG. 2C illustrates the zoomed portion 250 of FIG. 2B after surface features 202 of wafer 200 have flowed to form a new pattern. More specifically, in the illustrated embodiment, the dispensed epoxy droplets or dots forming non-continuous patterns 202a-202d of FIG. 2B have gradually flowed together to form a new pattern of continuous rectangular-shapes 202a′-202d′. In some embodiments, wafer 200 may include additional features that guide the flow of features 202, such as, for example, a raised sidewall or a trough. Inspection tool 102 may generate inspection data for wafer 200 after features 202 have flowed to form a stable, semi-solid pattern, as shown in FIG. 2C; however, inspection tool 102 may generate inspection data at any suitable time. The inspection data may include, for example, spatial information related to features 202 and 204 relative to one or more reference points of wafer 200, such as a notch or some other suitable reference point. Data-analyzer application 112 may perform any of a variety of analyses on the data generated by inspection tool 102, as described further below with reference to FIG. 3A and 3B.

FIG. 3A illustrates an example portion of an analytical mask 300 that may be used by data-analyzer application 112 to analyze data generated by inspection tool 102 according to one embodiment. In the illustrated embodiment, analytical mask 300 generally represents a predetermined pattern that defines the expected final pattern of a flowing substance, such as an epoxy, applied to the surface of wafer 200. In particular, analytical mask 300 includes masked regions that map out the expected pattern. In the illustrated example, the horizontal and vertical lines generally align with the flowed dispense patterns 202a′-202f′. Data analyzer application 112 may filter out all spatial data generated by inspection tool 102 that is spatially located within the boundaries defined by analytical mask 300. Data-analyzer application 112 may then use the remainder of the generated spatial data to extrapolate defect information, as illustrated further with reference to FIG. 3B.

FIG. 3B illustrates an example portion of a defect map 350 generated by data analyzer application 112 that graphically represents the extrapolated defect information of FIG. 3A according to one embodiment. More specifically, in the illustrated example, defect map 350 represents aberrations 204a-204i of FIG. 3A that are located outside the masked areas of mask 300. In some embodiments data-analyzer application 112 may be capable of calculating the total number of defects of a particular portion of wafer 200, such as the nine aberrations 204a-204i of portion 250, or the total number of defects for the entire wafer 200.

In some embodiments, data-analyzer application 112 may present defect map 350 to a user in the graphical user interface (GUI). For example, such a GUI may enable a user to zoom in on a particular region of the inspection data, measure particular defects, and/or overlay the inspection data of several inspection samples. In addition, the GUI may enable a user to set up the parameters for analytical mask 300, including for example, the pitch, gap, tolerance, and alignment of features 202.

A series of defect maps 350 may enable a user and/or automated software to recognize reoccurring defect patterns or defect severity, thereby providing a feedback mechanism that may facilitate, for example, the optimization of a dispense process. In addition, data analyzer application 112 may record data corresponding to the extrapolated defect information and/or communicate the same to a client. For example, data analyzer application 112 may store such data within storage 112, or any other suitable computer read-able media, which may then be retrievable by a remotely located computer.

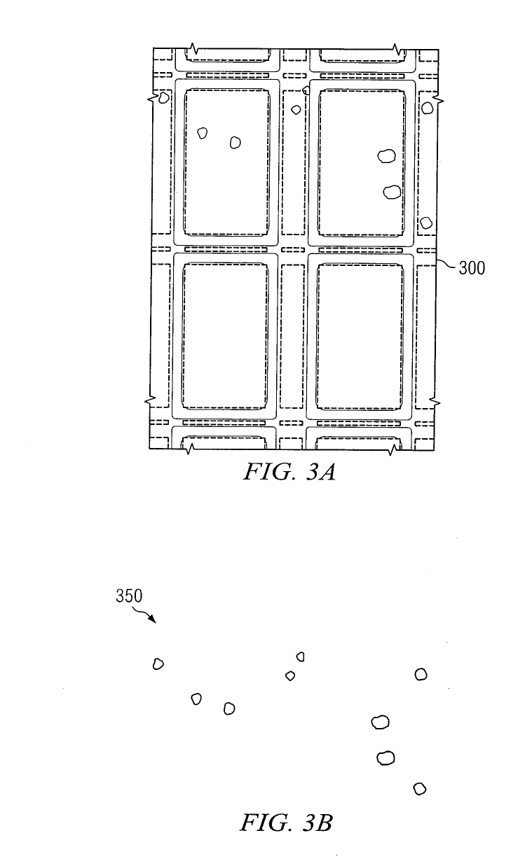

FIG. 4 illustrates an example of a method 400 that may be performed by the inspection system of FIG. 1 according to one embodiment. In step 402, inspection data is received from optical inspection tool 102. The inspection data may represent, for example, a plurality of surface features of a wafer. In step 404, the inspection data is compared to a predetermined pattern. For example, the predetermined pattern may correspond to a dispense pattern formed by dispensing a flowing substance on the surface of a wafer. In step 406, a determination is made, based at least in part on the comparison, as to whether or not the inspection data indicates one or more defects.

Modifications, additions, or omissions may be made to the methods described herein without departing from the scope of the invention. The method may include more, fewer, or other steps. Additionally, steps may be performed in any suitable order.

An advantage of certain embodiments of the present disclosure may be that various inspection tools 102 (including, for example, inspection tools without masking or pattern detection capabilities) may be used to generate inspection data, which may then be analyzed off-line using a stand-alone, highly configurable, data-analyzer application 112. Another advantage of certain embodiments is that lower-precision and less-repeatable processes, such as epoxy droplet dispensing, may be analyzed, characterized, and optimized. In addition, some embodiments may be able to generate and analyze inspection data corresponding to the application of a flowing substance to a wafer. Some embodiments may enable faster and higher resolution inspections.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed:

1. An inspection system, comprising:
a computer communicatively coupled to an inspection tool operable generate inspection data corresponding to the features of a wafer, the computer comprising:
a central processing unit; and
a storage comprising a data-analyzer application operable to:
receive the inspection data from the inspection tool;
compare the inspection data to a final pattern, the final pattern representing results of an epoxy dispensed on a surface of the wafer; and
generate defect information based at least in part on the comparison.

2. The inspection system of claim 1, the final pattern representing a flow of the dispensed epoxy across the surface of the wafer from an initial pattern.

3. The inspection system of claim 1, the generated defect information comprising a total number of discrete defects.

4. The inspection system of claim 1, the generated defect information comprising a location of one or more defects, the location relative to at least one feature of the wafer.

5. The inspection system of claim 1, the computer further comprising a display operable to present a graphical user interface (GUI), the graphical user interface (GUI) enabling the user to change a graphical representation of the one or more defects.

6. A method, comprising:
accessing inspection data received from an inspection tool, the inspection data describing a plurality of surface features of a substrate;
comparing the inspection data to an expected pattern, the expected pattern representing expected flow results of a flowing substance dispensed on a surface of the substrate; and
determining, based at least in part on the comparison, if the inspection data indicates one or more defects.

7. The method of claim 6, further comprising:
determining the expected pattern based at least in part on an anticipated flow of the dispensed flowing substance.

8. The method of claim 6, further comprising calculating a total number of the one or more defects.

9. The method of claim 6, further comprising determining a location of the one or more defects, the location relative to at least one feature of the substrate.

10. The method of claim 6, further comprising optimizing, based at least in part on the determination, a dispense process operable to dispense the flowing substance on the surface of the substrate.

11. The method of claim 6, the flowing substance comprising an epoxy.

12. The method of claim 6, further comprising communicating a defect map to a graphical user interface (GUI), the defect map graphically displaying the one or more defects.

13. The method of claim 6, the expected pattern different from an initial dispense pattern.

14. Logic encoded in computer-readable media and operable when executed to:
access inspection data received from an inspection tool, the inspection data representing a plurality of surface features of a substrate;
compare the inspection data to a stable pattern representing results of a flowing substance dispensed on a surface of the substrate; and
generate defect data based at least in part on the comparison.

14. The logic of claim 14, the logic further operable to:
determine the stable pattern based on an anticipated flow of the dispensed flowing substance from a dispense pattern.

15. The logic of claim 14, the generated defect data comprising a total number of discrete defects.

16. The logic of claim 14, the generated defect data comprising a location of one or more defects, the location relative to at least one feature of the substrate.

17. The logic of claim 14, the logic further operable to:
optimize, based at least in part on the determination, a dispense process operable to dispense the flowing substance on the surface of the substrate.

18. The logic of claim 14, the flowing substance comprising an epoxy.

19. The logic of claim 14, the logic further operable to:
communicate a defect map to a graphical user interface (GUI), the defect map corresponding to the generated defect data.

20. The logic of claim 14, the stable pattern different from a dispense pattern representing the flowing substance as dispensed.
